(19) United States
(12) Patent Application Publication
(10) Pub. No.: US 2002/0071743 A1
(43) Pub. Date: Jun. 13, 2002

(54) Container cargo transfer system

(76) Inventor: W. J. Amoss JR., New Orleans, LA (US)

Correspondence Address: GARVEY SMITH NEHRBASS & DOODY, LLC, THREE LAKEWAY CENTER, 3838 NORTH CAUSEWAY BLVD., SUITE 3290, METAIRIE, LA, 70002

(21) Appl. No.: 09/735,343

(22) Filed: Dec. 11, 2000

Related U.S. Application Data
(60) Provisional application No. 60/170,270, filed on Dec. 11, 1999.

(51) Int. Cl. B65G 63/00

(52) U.S. Cl. 414/137.9; 414/140.1; 414/140.4; 414/141.6

(57) ABSTRACT

A platform container transfer terminal (10) functions as an efficient hub port. Sea Point™ Transfer station modules (21, 22, 23) can be moved intact across oceans for rapid erection in remote or strategic locations to provide high speed loading and unloading of large container vessels (31, 32) to lighters or feeder vessels (41, 42, 43, 44, 45) and/or to facilities adjacent.

### CROSS-REFERENCE TO RELATED APPLICATIONS

Priority of U.S. Provisional patent application Ser. No. 60/170,270, filed Dec. 11, 1999, incorporated herein by reference, is hereby claimed.

### BACKGROUND OF THE INVENTION

1. Field of the Invention

The present invention relates to cargo transfer systems. More particularly, the present invention relates to systems for transferring cargo between ocean-going vessels and land destinations or ocean-going vessels and barges or between ocean-going vessels, barges, and landside terminals.

2. General Background of the Invention

At present large container vessels provide economies of scale by carrying very large numbers of intermodal containers and container derivative devices such as flat racks and open tops containers. Such large ships today carry more than 6000 twenty foot equivalent units (TEU) and still larger ocean-going vessels are foreseen. The containers carried by these large vessels are generated by several regional ports spread geographically over areas such as South East Asia, UK/North Europe or a US coastal region. This requires the large vessel to either make multiple port calls, some times once to discharge and later to double back to load, or by using a port in the region as a hub port where the large vessel proceeds to a landside terminal, from which containers are both landed for local distribution and transshipped to feeder vessels or barges and/or to trucks or rail cars, for distribution to other port destinations. The terminal operation required at landside hub ports is extensive and costly involving trucking from quay to storage in stacks and load out in a reverse operation at later dates to on carrying vessels.

Typically, import containers discharged from a large carrier vessel at a landside terminal are hauled from the dock side to stacked storage on the back side of the terminal or placed on wheeled chassis and parked for later haul back to cranes for loading to feeder vessels or to rail cars at distant sidings or transferred to trucks for delivery to other ports or inland locations.

Outbound containers are received at a landside terminal from rail sidings, often at remote locations or from drays and long haul trucks or feeder vessels and assembled on the backside of the terminal awaiting the arrival and readiness of the large carrier to load. Hundreds of acres of land are required for such operations in addition to the several handling operations involved.

The critical matter of road and rail infrastructure required for landside terminals to accommodate large vessels can take decades to develop and billions of dollars in cost. Environmental issues may also intervene.

In Vietnam, a jack-up causeway was used to unload containers from ships. The causeway was used as a dock where trucks took the containers as they were unloaded and hauled away.

The Freeport Sulphur mine is a series of jack-up barges strung together.

The following U.S. Pat. Nos. are incorporated herein by reference:

2,308,743; 3,183,676; 3,290,007; 3,367,119; 3,606,251; 3,750,210; 3,945,450; 3,967,457; 4,310,277; 4,363,411; 4,417,664; 4,456,404; 4,465,012; 4,482,272; 4,505,616; 4,544,137; 4,547,857; 4,568,232; 4,589,799; 4,627,768; 4,632,622; 4,652,177; 4,678,165; 4,722,640; 4,762,456; 4,813,814; 4,916,999; 5,028,194; 5,139,366; 5,224,798; 5,580,189; 5,797,703; 5,807,029; and all patents mentioned herein.

U.S. Pat. No. 4,762,456 discloses a cargo container loading and unloading operation where a floating crane is used to transfer containers between deep draft ships and shallow draft ships.

U.S. Pat. No. 4,363,411 (see col. 3, lines 44-53) discloses a loading/unloading crane system that is placed between the ocean and a lagoon to handle deep draft and shallow draft ships at the same time.

U.S. Pat. No. 4,465,012 discloses a floating crane transhipment device to accommodate movement of cargo between ships and barges.

U.S. Pat. No. 4,568,232 discloses a floating horizontal boom bulk unloader that allows shallow draft ships to be loaded and unloaded from a deep draft ship.

U.S. Pat. Nos. 4,310,277; 4,457,85; 4,544,137; 4,632,622; and 5,028,194 disclose cargo transfer systems supported on open sea platforms with one or more cranes.

### BRIEF SUMMARY OF THE INVENTION

The apparatus of the present invention solves the problems confronted in the art in a simple and straightforward manner. What is provided is a platform container transfer terminal that functions as an efficient hub port. Sea Point™ Terminal modules can be constructed to move intact across oceans for rapid erection in remote or strategic locations to provide high speed loading and unloading of large container vessels to lighters or feeder vessels and/or to/and facilities adjacent.

One embodiment of the present invention includes a container offloading facility made of jack-up barges. There can be, for example, four jack-up barges, each barge from 100 feet (30.5 m) to 700 feet (213.4 m) (e.g., 450 feet (137.2 m)) long and 25 feet (7.62 m) to 250 feet (76.2 m) (e.g., 100 feet (30.5 m)) wide, in an ocean-going hull design, with e.g. a 20 foot (6.1 m) 1-5 hull depth, and placed end-to-end to provide a platform (e.g. 1800 feet (548.6 m) long). There can be multiple (for example, 4) cranes per platform. The facility could advantageously be placed at the mouth of a river (such as at the mouth of the Mississippi River) to provide a sea coast or near sea coast transfer port for large vessels.

The container cranes used with the facility of the present invention can include a boom on the backside which is much longer than a conventional backside boom on a land terminal.

This facilitates loading the feeder vessels or barges while at the same time offloading the ocean-going container or cargo ships (and vice versa).

The present invention also comprises a method of transporting goods, comprising using a jack-up barge to transfer goods from an ocean-going vessel to a barge or other shallower-draft feeder vessel.

The present invention also comprises a method of transporting goods, comprising using a pile-supported platform deck on which cranes operate to transfer goods from an ocean-going vessel to a barge or other type feeder vessels.

The present invention can be constructed as a floating mobile terminal or as a fixed terminal on pile or material foundation. The Sea Point™ platform concept consists of a platform structure erected in a semi-sheltered location such as at the mouth of a river, bay, sound or inlet with sufficient water depth, natural or dredged, to accommodate ocean-going vessels on one side and feeder vessels or barges on the opposite side. The platform may be constructed on pilings in the manner of a pile-supported dock, as an artificial island built up of material, or as floating modules with spud legs which can be towed intact to remote transoceanic locations and combined for rapid jack-up assembly as one platform made from multiple modules at the chosen site. Floating modules with jack-up supporting legs that can be embedded in the solid bottom material allows almost immediate erection of the platform to its desired height ready to accommodate container transfers between large carriers on one side and feeder vessels or barges on the opposite side. Towable jack-up platform modules are particularly attractive for military rapid deployment needs and could be a valuable element of U.S. prepositioned forces or reserve fleet components.

The platform (FIG. 1) serves as the base for container handling cranes one version of which has been designed to have an extreme reach on the large vessel side as well as on the feeder side so that even a postpanamax vessel (over 105 feet (32 m) wide) up to 200 feet (61 m) wide can be loaded or discharged by the container crane boom on the large vessel side to or from barges or feeders docked two or more (e.g., four) wide up to +200 feet (61 m) off the feeder vessel side. These container cranes using state-of-the-art hoisting speed at lifting capacity and with high horizontal travel speeds can, in one transfer cycle, lift two or more loaded containers at a time and rapidly transfer them to or from stowed positions on the feeders. Feeder vessels or barges being shorter and less wide and deep than large container carriers can be berthed on the platform side opposite the larger vessels in multiple sets (FIG. 2) so that distribution to multiple destinations can be served quickly by loading some feeders with specifically destined containers and dispersing them immediately upon completion of discharge. Simultaneously, outbound cargo would be brought to Sea Point™ by separate feeder vessels or barges and placed along side the platform feeder side to be transferred to the large vessel as soon as the loaded feeders are taken away from the dock.

During loading or discharge at a Sea Point™ transfer platform, outport destined containers may be landed to transfer cars stationed under the crane legs on designated road ways that may run in opposite directions in order to distribute such containers to other cranes serving feeders for their destinations (FIGS. 3 and 4). This would be accomplished by vehicles (for example, light tractors) hauling these containers (e.g., on cars or chassis) to those cranes loading the desired feeders, reducing the necessity for stacking or grounding containers on the platform during cargo operations. The container crane can also be designed to have two separate cabs with traveling trolleys that move outward from a center raised platform located between the legs of the crane; this provides rapid transfer from each side that will speed up the loading and discharge cycles substantially (FIGS. 3 and 4).

A pile-supported platform or a platform on a built-up material (spoil or otherwise) island can be used as the foundation for the transfer platform of the present invention, which in cases where mobility is of no value, would be a cheaper mode of construction.

Other configurations of transfer cranes have certain advantages where alternative container cells on the large vessels and/or the feeder vessels are served by special crane arrangements as shown, for example, in FIGS. 5-8.

The delivery to various Port terminals by feeder barges or feeder vessels permits each port terminal to be designed to discharge the less costly unmanned vessel units, direct to rail car and truck lanes located along the dockside within the reach of port cranes' terminal side. Extended landside booms on port cranes can accomplish this efficiently and provide added opportunity by placing containers directly on stacks in the terminal yard saving costly terminal handlings and reducing significantly the acreage required for each container terminal. The Sea Point™ platform can also be placed so as to provide offloading from large vessels to feeders and to adjacent terminal docks by locating the platform in water at a distance of about 100 feet (30.5 m) from the land terminal thus allowing one or more (e.g., two) feeder vessels to be berthed between the Sea Point™ platform and land terminal. The long (e.g., 200 foot (61 m)) reach of the crane's booms on each side of the platform would allow transfers between the land terminal, feeder vessels and the large vessel as desired.

The critical matter of road and rail infrastructure required for landside terminals to accommodate large vessels can take decades to develop and billions of dollars in cost. Environmental issues may also intervene. In contrast a Sea Point™ transfer platform can be fabricated for erection in appropriate water depth locations in less than two years time and its size is unlimited. Ideally, Sea Point™ platforms can also be phased in to provide an initial length and width to handle, for instance, the next half decade of expected use and then expanded to any greater length or width when required.

The present invention comprises a method of transporting goods, comprising:

providing a jack-up barge;

providing a crane on the jack-up barge;

transferring goods from an ocean-going vessel to a barge or other shallower-draft feeder vessel using the crane on the jack-up barge. Preferably, the jack-up barge is positioned at the mouth of a river.

The present invention also comprises a system for transshipping containerized cargo, comprising:

a jack-up barge;

a crane on the jack-up barge for transferring goods from an ocean-going vessel to a barge or other shallower-draft feeder vessel using the crane on the jack-up barge.

The present invention further comprises a system for transshipping containerized cargo, comprising:

a plurality of jack-up barges connected together end-to-end to form a transshipping platform;

cranes on the jack-up barges for transferring goods from ocean-going vessels to barges or other shallower-draft feeder vessels using the cranes on the jack-up barges. Preferably, the jack-up barges are each about 450 feet (137.2 m) long and about 100 feet (30.5 m) wide, with about a 20 foot (6.1 m) hull depth and an ocean-going hull design. Preferably, there are at least four cranes. Preferably, there is also an upper transfer platform above the transshipping platform. Preferably, there are also cargo transfer roadways on the transshipping platform.

The platform is preferably at least 100-200 feet (30.5-61 m) long, more preferably at least 300 feet (91.4 m) long, even more preferably at least 400 feet (121.9 m) long, and most preferably at least 500 feet (152.4 m) long; the platform is preferably 20-1000 feet (6.1 m-305 m) wide, more preferably 40-500 feet (12.2 m-152.4 m) wide, and most preferably 60-200 feet (18.3-61 m) wide.

### BRIEF DESCRIPTION OF THE SEVERAL VIEWS OF THE DRAWINGS

For a further understanding of the nature, objects, and advantages of the present invention, reference should be had to the following detailed description, read in conjunction with the following drawings, wherein like reference numerals denote like elements and wherein:

FIG. 1 is a side view of a first embodiment of the apparatus of the present invention;

FIG. 2 is a top view of the first embodiment of the apparatus of the present invention;

FIG. 3 is a side view of a second embodiment of the apparatus of the present invention;

FIG. 4 is a top view of the second embodiment of the apparatus of the present invention;

FIG. 5 is a side view of a third embodiment of the apparatus of the present invention;

FIG. 6 is a top view of the third embodiment of the apparatus of the present invention;

FIG. 7 is a side view of a fourth embodiment of the apparatus of the present invention; and

FIG. 8 is a top view of the fourth embodiment of the apparatus of the present invention.

### DETAILED DESCRIPTION OF THE INVENTION

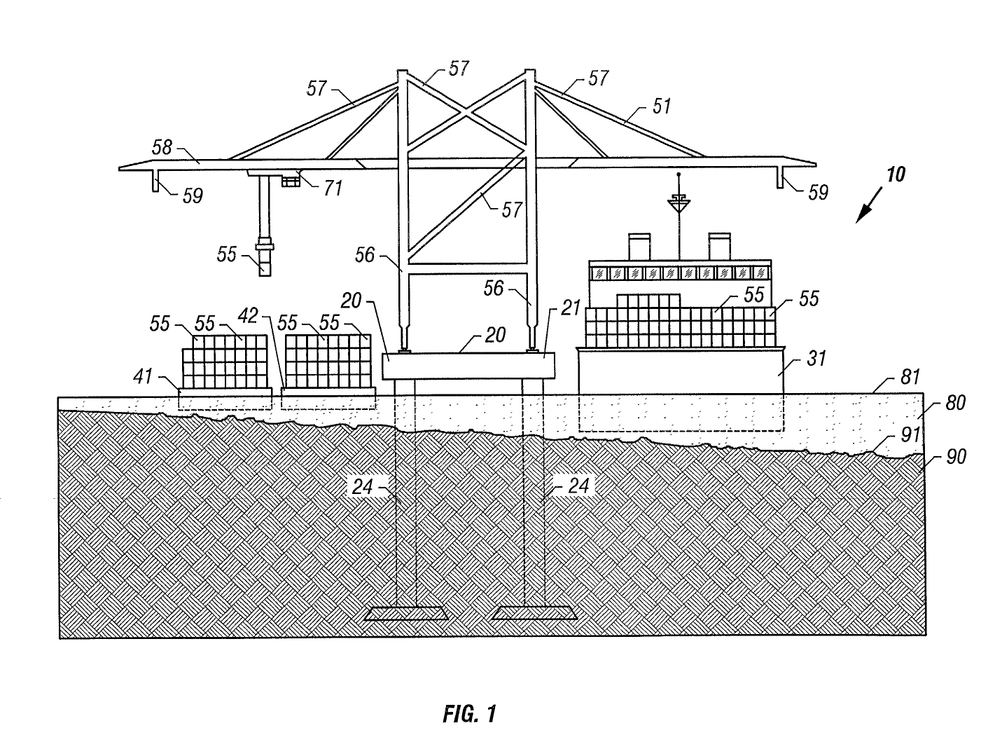

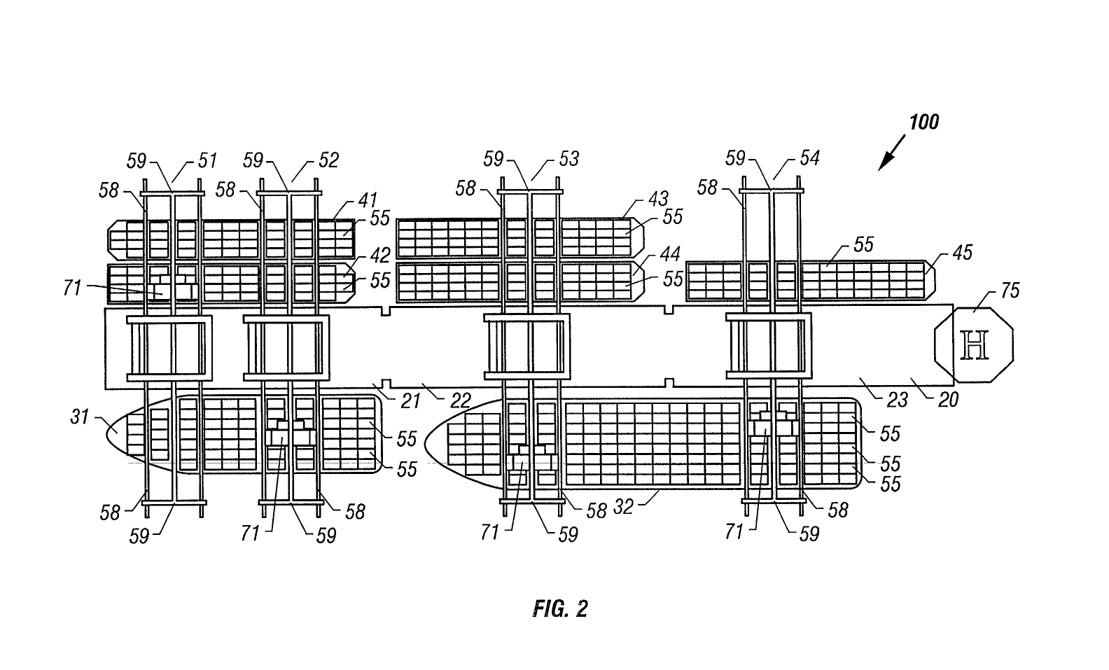

The Sea Point™ platform apparatus 10 (FIGS. 1 and 2) of the first embodiment of the present invention comprises a platform structure 20 erected in a semi-sheltered location such as at the mouth of a river, bay, sound or inlet with sufficient water depth, natural or dredged, to accommodate ocean going vessels 31, 32 on one side and feeder vessels or barges 41,42,43,44, 45 on the opposite side. For example, the platform apparatus of the present invention can be installed in the Mississippi River near Venice, LA, US, adjacent the West bank at mile 12.2 above head of passes.

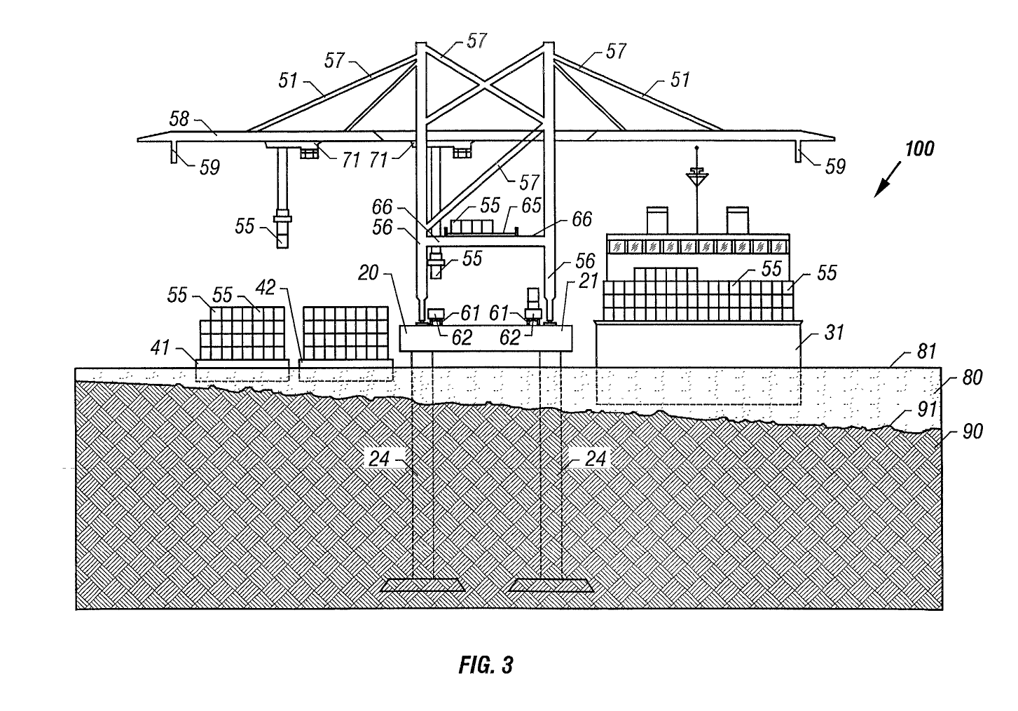

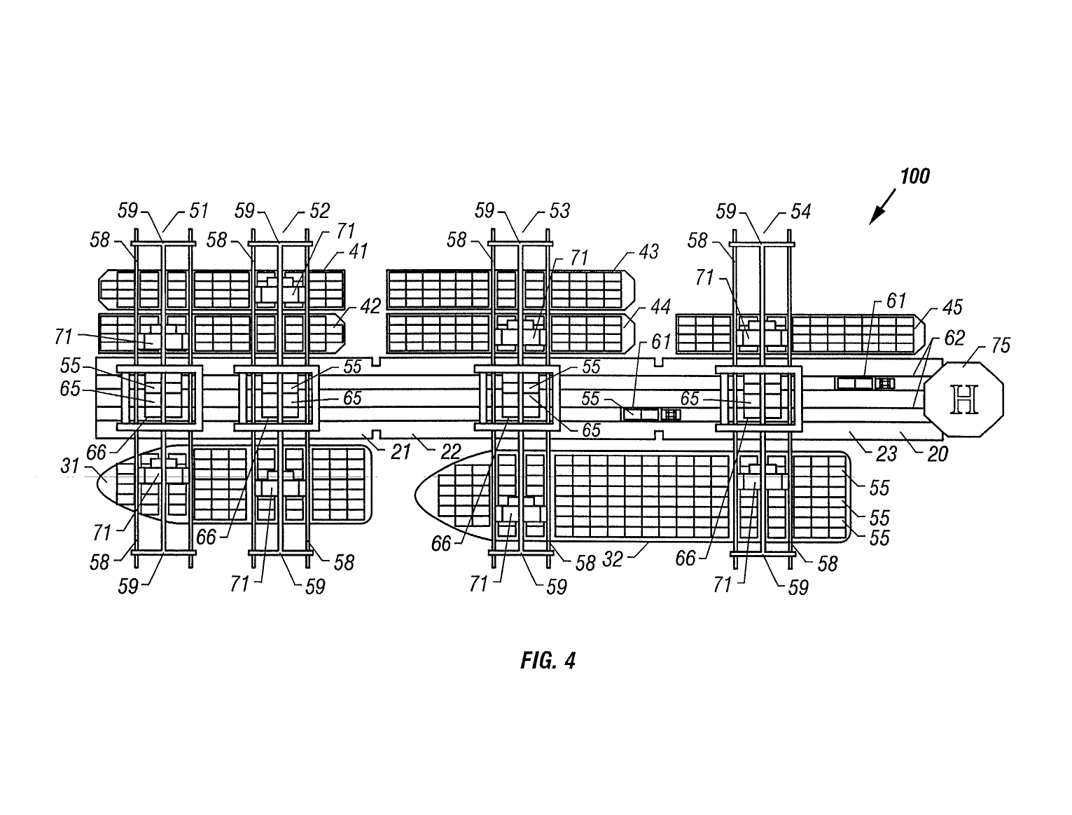

Platform apparatus 10 (FIGS. 1 and 2) is similar to platform apparatus 100 (FIGS. 3 and 4) but lacks upper transfer platform 65 and the double trolley system of platform apparatus 100. Both platform apparatus 10 and platform apparatus 100 include a helicopter pad (heliport) 75 at one end thereof.

The platform 20 may be constructed on pilings in the manner of a pile-supported dock or as modules 21, 22, 23 with spud legs 24 which can be towed, floating, intact to remote transoceanic locations for rapid jack-up assembly as one terminal made from multiple modules 21, 22, 23 at the chosen site. Floating modules 21, 22, 23 with jack-up supporting legs 24 that can be embedded in the solid bottom material allow almost immediate erection of the platform 20 to its desired height ready to accommodate container transfers between large carriers 31, 32 on one side and feeder vessels or barges 41,42,43,44,45 on the opposite side. Towable jack-up platform modules 21, 22, 23 are particularly attractive for military rapid deployment needs and could be a valuable element of U.S. prepositioned forces or reserve fleet components. As shown in the drawings, the platform 20 is set out an appropriate height above the water line 81 of water 80, with spud legs 24 extending below the mud line 91 and through mud 90.

The platform 20 (FIG. 1) serves as the base for container handling cranes 51, 52, 53, 54 that can be designed to have an extreme reach on the large vessel side as well as on the feeder side so that a panamax vessel 31 105 feet (32 m) wide, or a postpanamax vessel 32 up to 200 feet (61 m) wide can be loaded or discharged by the container boom on the large vessel side to or from feeders 41, 42, 43, 44, 45 docked two or more wide up to about 200 feet (61 m) off the feeder vessel side. These container cranes 51, 52, 53, 54 using state of the art lifting speed and capacity and horizontal travel speeds can, in one transfer cycle, lift two or more loaded containers 55 at a time and rapidly transfer them to or from stowed positions on the feeders. Cranes 51,52, 53, 54 can be similar to standard gantry container handling cranes, and similar in construction to the cranes shown in U.S. Pat. Nos. 4,363,411; 4,568,232; and 4,762,456. Cranes 51,52, 53, 54 each include crane legs 56, gantries 58 supported on legs 56, bracing 57 which interconnects legs 56 and which connects legs 56 to gantries 58, and trolley stops 59 to prevent the trolleys 71 from falling off of the ends of the gantries 58.

Feeder vessels or barges 41, 42, 43, 44, 45 being shorter and less wide than large container carriers 31, 32 can be berthed on the platform side opposite the larger vessels 31, 32 in sets (FIG. 2) so that distribution to multiple destinations can be served quickly by loading the feeders with specifically destined containers and dispersing immediately upon completion of discharge. Simultaneously, outbound cargo would be brought to Sea Point™ by separate feeder vessels or barges 41, 42, 43, 44, 45 and placed alongside the platform to be transferred to the large vessels 31, 32 as soon as the empty feeder is taken away from the dock. It is also possible to use one vessel/barge as a carrier for export and import transfered containers.

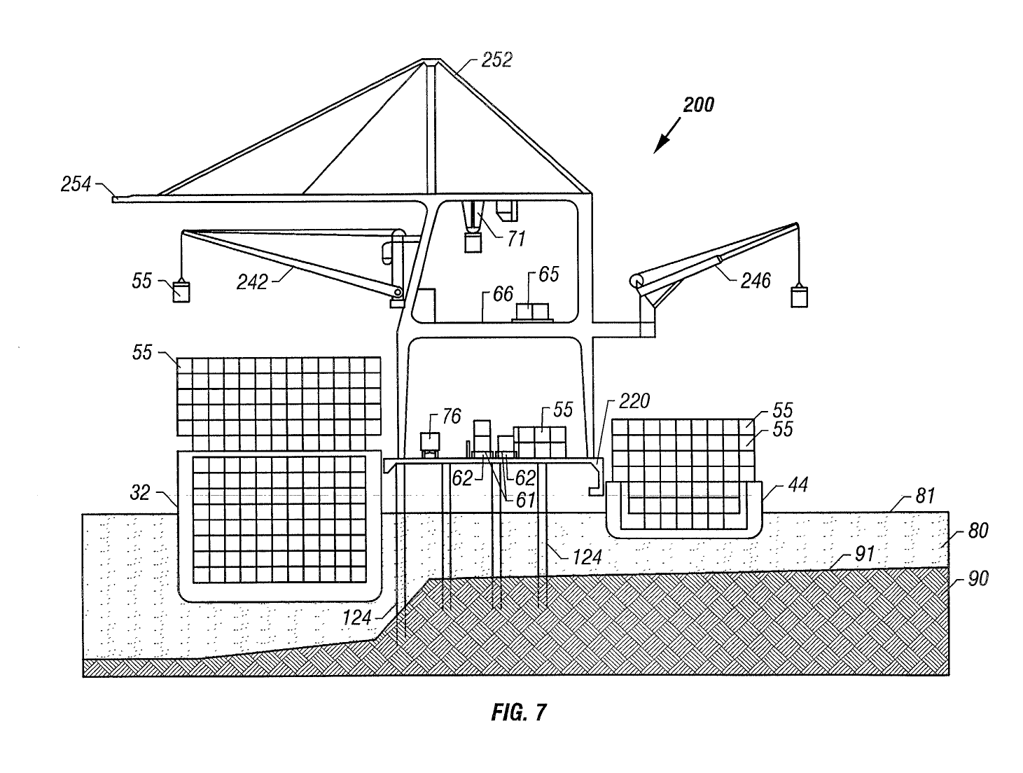

During loading or discharge at a Sea Point™ transfer platform, outport destined containers 55 may be landed to one or more transfer cars 61 stationed under the crane legs 56 on designated road ways 62 that may run in opposite directions so as to distribute such containers 55 to cranes serving feeders for their destinations (FIG. 3). This would be accomplished by vehicles (such as light tractors 76—see FIG. 7) hauling these containers on cars or chassis 61 to cranes loading the desired feeders, reducing or eliminating any necessity for stacking or grounding containers on the platform during cargo operations. The container cranes 51, 52, 53, 54 can also be designed to each have two separate cabs and traveling trolleys 71 that move outward from a center raised transfer rack 65; this provides rapid transfer from each side that will speed up the loading and discharge cycles substantially (see FIG. 3). As shown in FIG. 3, containers 55 can rest on transfer rack 65 while waiting to be transferred between ships 31, 32, and barges 41, 42, 43, 44, or 45. Adjacent transfer rack 65 are openings 66 to allow containers 55 to move from the cranes 51, 52, 53, 54 to road ways 62.

The delivery to various port terminals by feeder barges or feeder vessels 41, 42, 43, 44, 45 permits each port terminal to be designed to discharge these less costly vessel units 41, 42, 43, 44, 45, direct to rail car and truck lanes located along the dockside within the reach of port cranes' terminal side. Extended landside booms on port cranes can accomplish this efficiently and provide added opportunity that save several costly terminal handlings and reduces significantly the acreage traditionally required for each container terminal. The Sea Point™ platform apparatus can also be placed so as to provide offloading from large vessels to feeders and to adjacent terminal docks by locating the platform in water at a distance of about 100 feet (30.5 m) from the land terminal thus allowing one feeder vessel to be berthed between the Sea Point™ platform and land terminal. The reach (e.g. 200 feet-61 m) of the crane on each side of the platform would allow transfers between the land terminal, feeder vessels and the large vessel as desired.

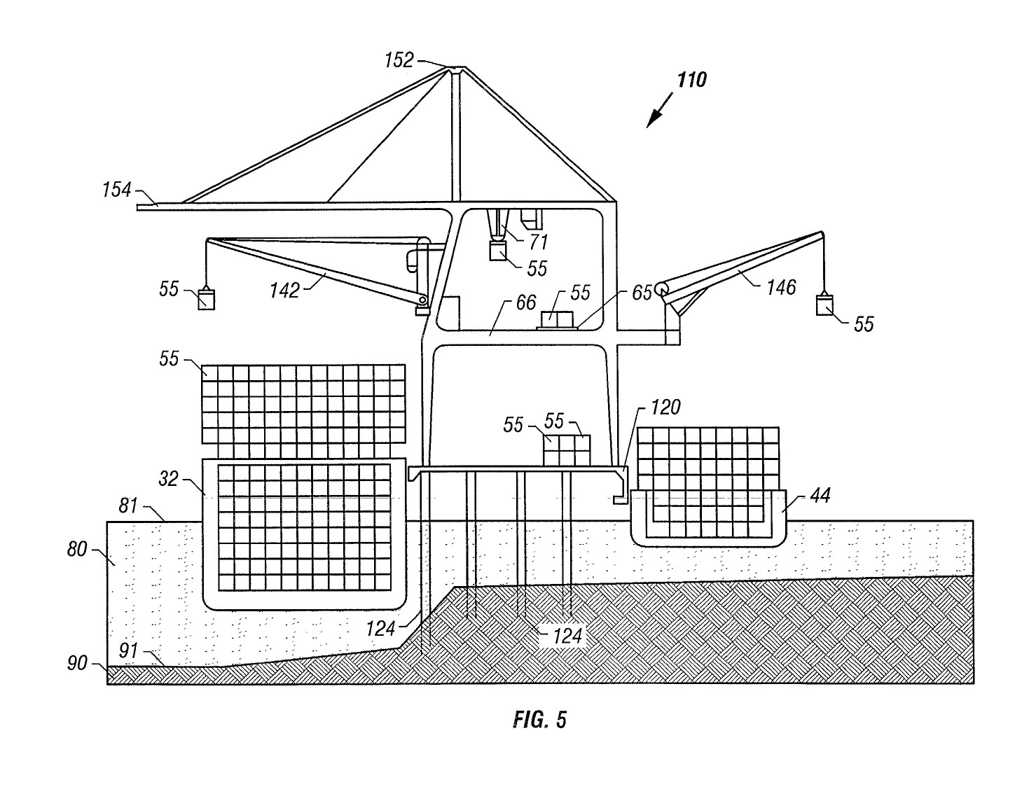

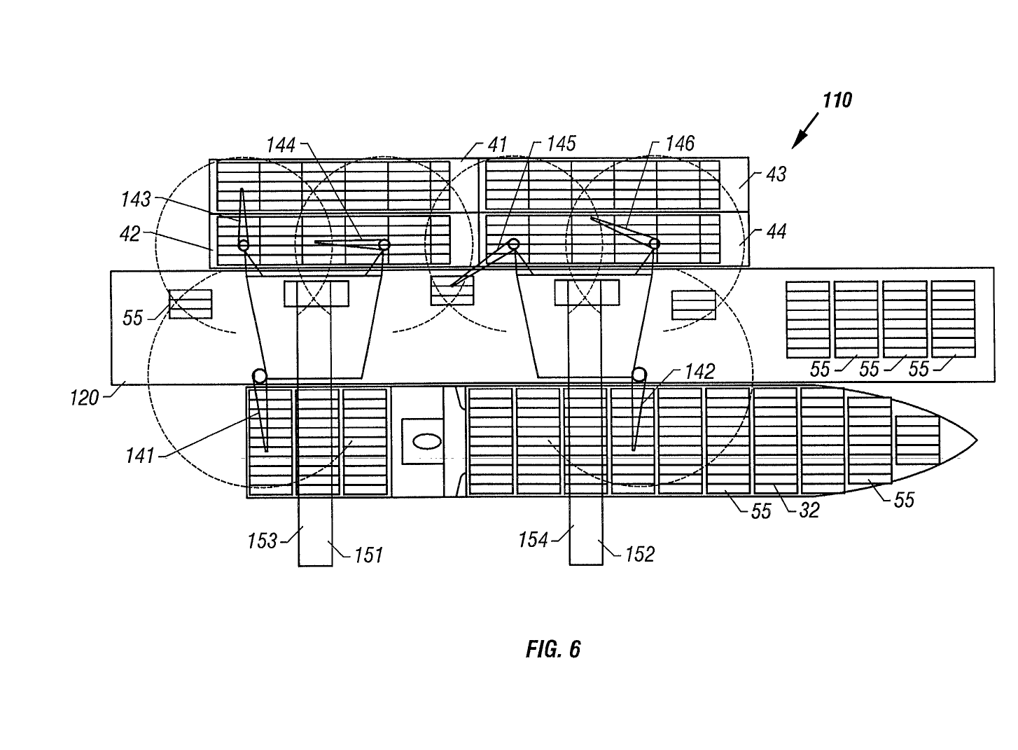

The platform apparatus 110 of the third embodiment of the present invention is shown in FIGS. 5 and 6. Apparatus 110 includes a platform 120 supported by piles 124 imbedded in mud 90. Two container handling gantry cranes 151 and 152 are shown in FIG. 6. Crane 151 includes a gantry 153, a boom crane 141 with lifting hoist, and pedestal type boom cranes 143 and 144 with lifting hoists. Crane 152 includes a gantry 154, a boom crane 142 with lifting hoist, and pedestal type boom cranes 145 and 146 with lifting hoists.

The circles in FIG. 6 show the reach of the various cranes. As can be seen in FIG. 6, there are two storage stacks of containers 55 out of reach of the cranes (these containers 55 can be moved around by light tractors 76—see FIG. 7), and various stacks of containers 55 are shown which can be reached by more than one crane. In FIG. 6, the barges 41, 42, 433, and 44 can be partially unloaded onto platform 120 before ship 32 arrives to minimize dock time of ship 32.

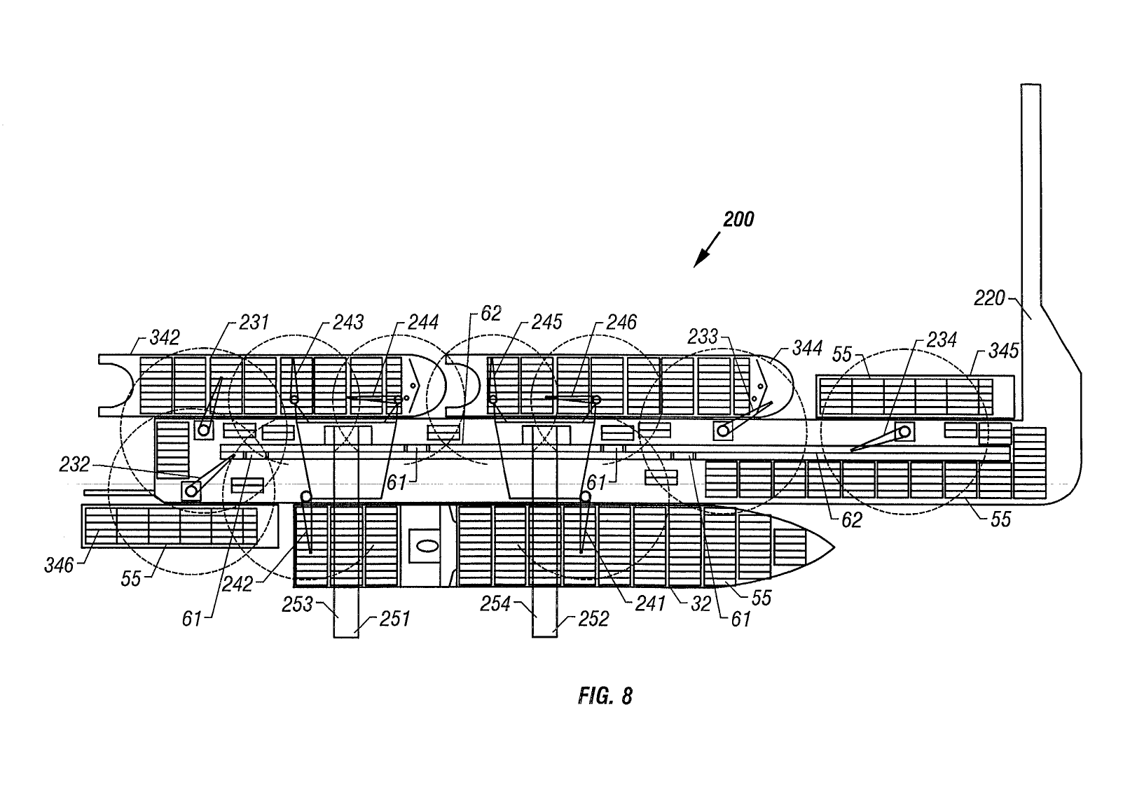

The platform apparatus 200 of the fourth embodiment of the present invention is shown in FIGS. 7 and 8. Apparatus 200 includes a platform 220 on which are mounted two container handling gantry cranes 251 and 252. Crane 251 includes a gantry 253, a boom crane 241 with lifting hoist, and telescopic boom cranes 243 and 244 with lifting hoists. Crane 252 includes a gantry 254, a boom crane 242 with lifting hoist, and telescopic boom cranes 245 and 246 with lifting hoists.

The circles in FIG. 8 show the reach of the various cranes. As can be seen in FIG. 8, there are four mobile harbor cranes 231, 232, 233, and 234. The containers 55 out of reach of the fixed cranes can be moved around by light tractors 76—see FIG. 7—or by the mobile harbor cranes 231, 232, 233, and 234. FIG. 8 shows a causeway 225 from platform 220 to shore (not shown). This causeway 225 allows platform 220 to be supplied from shore as well as by barge and ship.

The various cranes shown in FIG. 8, the light tractors 76, and cars 61 move containers 55 among ship 32, feeder vessels 342 and 344, and barges 345 and 346.

In FIG. 8, the barges 345 and 346 can be partially unloaded onto platform 220 before ship 32 arrives to have empty slots available for the ship containers to minimize dock time of ship 32.

In FIG. 8, the gantry trolleys 71 unload above-hatch containers until the first hatch is cleared. Hatch covers are removed and cargo containers are unloaded to the bottom of the cell. Once a cell has been cleared, the cargo operations using trolleys to load and unload containers with each trolley move. The gantry trolleys 71 and the boom cranes 241 and 242 work the ship cargo. The gantry trolleys 71 deliver containers to the fixed container racks 65. The trolleys 71 may also land containers 55 on the shuttle cars 61 or on the platform 220 along the ship 32.

The cranes 243, 244, 245, 246 attached to the barge side of the gantries 253, 254 load from rack 65 to barges/feeder vessels 342, 344 and back. These cranes may also work to and from the dock transfer areas and the shuttles 61.

The boom cranes 241,242 unload containers to the shuttle cars 61 or to the dock transfer areas.

The mobile harbor cranes 231, 232, 233, and 234 are set to work the barges 345 and 346 and feeder vessels 342 and 344 and stack.

All of the cranes are preferably equipped with anti-collision controls.

The critical matter of road and rail infrastructure required for landside terminals to accommodate large vessels can take decades to develop and billions of dollars in cost. Environmental issues may also intervene. In contrast a Sea Point™ transfer platform can be fabricated for erection in appropriate water depth locations in no more than two years time and size is unlimited. Ideally, Sea Point™ platforms can also be phased in to provide an initial size to handle, for instance, the next half decade of expected use and then expanded to any greater size when required.

PARTS LIST:

The following is a list of parts suitable for use in the present invention:

10 platform apparatus of a first embodiment of the present invention

20 platform structure of platform apparatus 10 and 100

21 jack-up module

22 jack-up module

23 jack-up module

24 spud legs

31 ocean-going vessel

32 ocean-going vessel

41 barge going to port C

42 barge going to port A

43 barge going to port B

44 barge going to port A

45 barge going to port D

51 container handling crane

52 container handling crane

53 container handling crane

54 container handling crane

55 loaded containers

56 crane legs

57 bracing

58 gantries

59 trolley stops

61 transfer cars

62 road ways

65 transfer rack of platform apparatus 100

66 openings adjacent rack 65

71 cabs and traveling trolleys

75 helicopter pad (heliport)

76 yard tractor

80 water

81 water line

90 mud

91 mud line

100 platform apparatus of the second embodiment of the present invention

110 platform apparatus of the third embodiment of the present invention

120 platform

124 piles for platform 120

141 boom crane with lifting hoist

142 boom crane with lifting hoist

143 pedestal type boom crane with lifting hoist

144 pedestal type boom crane with lifting hoist

145 pedestal type boom crane with lifting hoist

146 pedestal type boom crane with lifting hoist

151 container handling crane

152 container handling crane

153 gantry of crane 151

154 gantry of crane 152

200 platform apparatus of the fourth embodiment of the present invention

220 platform

225 causeway from platform 220 to shore

231 mobile harbor crane

232 mobile harbor crane

233 mobile harbor crane

234 mobile harbor crane

241 boom crane with lifting hoist

242 boom crane with lifting hoist

243 telescopic boom crane with lifting hoist

244 telescopic boom crane with lifting hoist

245 telescopic boom crane with lifting hoist

246 telescopic boom crane with lifting hoist

251 container handling crane

252 container handling crane

253 gantry of crane 251

254 gantry of crane 252

342 feeder vessel

344 feeder vessel

345 barge

346 barge

The circles show the reach of the various cranes.

Various features have been shown in various figure herein. Feature appearing in one figure can be used with apparatus in other figures. For example, though jack-up legs are shown in FIGS. 1 and 3, and pilings are shown in FIGS. 5 and 7, the platform in FIGS. 1 and 3 can be supported by pilings and the platform in FIGS. 5 and 7 can be supported by jack-up legs. Likewise, cranes appearing in one figure can be used with the apparatus shown in other figures. Also, various features shown in the various patents cited herein can be incorporated into the apparatus of the present invention.

Any suitable materials, such as steel, can be used to construct the apparatus of the present invention. For example, reinforced concrete can be used for the platform deck.

All measurements disclosed herein are at standard temperature and pressure, at sea level on Earth, unless indicated otherwise.

The foregoing embodiments are presented by way of example only; the scope of the present invention is to be limited only by the following claims.

1. A method of transporting goods, comprising:
providing a jack-up barge;
providing a crane on the jack-up barge;
transferring goods between an ocean-going vessel and barges or other shallower-draft feeder vessels using the crane on the jack-up barge to unload the ocean-going vessel by transfering its containers to the barges or other shallower-draft feeder vessels and vice versa.

2. The method of claim 1, wherein the jack-up barge is positioned at the mouth of a river.

3. A system for transshipping containerized cargo, comprising:
a jack-up barge;
a crane on the jack-up barge for transferring goods between an ocean-going vessel and a barge or other shallower-draft feeder vessel using the crane on the jack-up barge.

4. A system for transshipping containerized cargo, comprising:
a plurality of jack-up barges connected together end-to-end to form a transshipping platform;
cranes on the jack-up barges for transferring goods between ocean-going vessels and barges or other shallower-draft feeder vessels using the cranes on the jack-up barges.

5. The system of claim 4, wherein the jack-up barges are each about 450 feet (137.2 m) long and about 100 feet (30.5 m) wide, with about a 20 foot (6.1 m) hull depth and of an ocean-going hull design.

6. The system of claims 4 or 5, wherein there are at least four cranes.

7. The system of claims 4, 5, or 6, further comprising an upper transfer platform mounted on the crane above the transshipping platform.

8. The system of any one of claims 4-7, further comprising cargo transfer roadways on the transshipping platform.

9. The invention of any one of claims 1-3, wherein the jack-up barge is connected to a land site.

10. The invention of any one of claims 1-3, wherein the jack-up barge is not connected to a land site.

11. The invention of any one of claims 4-8, wherein the jack-up barges are connected to a land site.

12. The invention of any one of claims 4-8, wherein the jack-up barges are not connected to a land site.

13. A method of transporting goods, comprising:
providing a platform constructed over water;
providing a crane on the platform, wherein the crane is a gantry crane including a gantry trolley and at least one boom crane;
transferring goods between an ocean-going vessel and a barge or other shallower-draft feeder vessel using the crane on the platform.

14. The method of claim 13, wherein the platform is positioned at the mouth of a river.

15. A system for transshipping containerized cargo, comprising:
a platform constructed over water;
a crane on the platform for transferring goods between an ocean-going vessel and a barge or other shallower-draft feeder vessel using the crane on the platform, wherein the crane is a gantry crane including a gantry trolley and at least one boom crane.

16. The system of claim 15 for transshipping containerized cargo, wherein the platform comprises a plurality of jack-up barges connected together end-to-end to form a longer transshipping platform, and there are a plurality of cranes on the jack-up barges for transferring goods between ocean-going vessels and barges or other shallower-draft feeder vessels using the cranes on the jack-up barges.

17. The system of claim 16, wherein the jack-up barges are each about 450 feet (137.2 m) long and about 100 feet (30.5 m) wide, with about a 20 foot (6.1 m) hull depth and of an ocean-going hull design.

18. The system of claims 16 or 17, wherein there are at least four cranes.

19. The system of claims 16, 17, or 18, further comprising an upper transfer rack mounted on the crane above the transshipping platform.

20. The system of any one of claims 16-19, further comprising cargo transfer roadways on the transshipping platform.

21. The invention of any one of claims 13-20, wherein the platform is connected to a land site.

22. The invention of any one of claims 13-20, wherein the platform is not connected to a land site.

23. The invention of any prior claim, wherein at least one crane is a gantry crane including a gantry trolley and at least one boom crane.

24. The invention of any prior claim, wherein at least one crane is a gantry crane including a gantry trolley and at least two boom cranes.

25. The invention of any prior claim, wherein at least one crane is a gantry crane including a gantry trolley and at least three boom cranes.

26. The invention of any one of claims 23-25, wherein at least one boom crane is a telescoping boom crane.

27. The invention of any prior claim, wherein the apparatus includes at least one mobile harbor crane.

28. A system for transshipping containerized cargo, comprising:
a transshipping platform constructed over water;
a plurality of cranes on the transshipping platform for transferring goods between an ocean-going vessel and a barge or other shallower-draft feeder vessel using the cranes on the transshipping platform, wherein at least two of the cranes are gantry cranes including a gantry trolley, at least one boom crane, and an upper transfer rack mounted on the gantry crane above the transshipping platform;
a cargo transfer roadway on the transshipping platform.

29. The system of claim 28 for transshipping containerized cargo, wherein the platform comprises a plurality of jack-up barges connected together end-to-end to form a longer transshipping platform, and there are a plurality of cranes on the jack-up barges for transferring goods between ocean-going vessels and barges or other shallower-draft feeder vessels using the cranes on the jack-up barges.

30. The system of claim 29, wherein the jack-up barges are each about 450 feet (137.2 m) long and about 100 feet (30.5 m) wide, with about a 20 foot (6.1 m) hull depth and of an ocean-going hull design.

31. The invention of any one of claims 13-15, wherein the platform is fixed on piles or a material such as spoil or rock for its foundation.

32. The system substantially as described and shown herein.

33. The method substantially as described and shown herein.
